(19) United States
(12) Patent Application Publication
(10) Pub. No.: US 2018/0201747 A1
(43) Pub. Date: Jul. 19, 2018

(54) THERMOSET FOAMS AND MANUFACTURING PROCESS

(71) Applicant: SAINT-GOBAIN ISOVER, Courbevoie (FR)

(72) Inventors: Marie SAVONNET, Paris (FR); Pierre SALOMON, Courbevoie (FR); Edouard OBERT, Fleurines (FR)

(73) Assignee: SAINT-GOBAIN ISOVER, Courbevoie (FR)

(21) Appl. No.: 15/569,095

(22) PCT Filed: Apr. 19, 2016
(86) PCT No.: PCT/FR2016/050906

§ 371 Date: Oct. 25, 2017

(30) Foreign Application Priority Data
Apr. 27, 2015 (FR) 1553771

(51) Int. Cl. C08J 9/02

(52) U.S. Cl. CPC C08J 9/02; C08J 2205/052; C08J 2361/02; C08J 2203/10

(57) ABSTRACT

A process for the manufacture of a solid thermoset foam includes the following successive stages: (a) making available an expandable and thermosetting composition containing a sugar and an acid catalyst chosen from strong acids, phosphoric acid and acidic inorganic salts, (b) introducing the expandable and thermosetting composition into a mold or applying the expandable composition to a support as a film with a thickness at least equal to 1 mm, and (c) heating the expandable and thermosetting composition to a temperature at least equal to 140° C., so as to form a block of solid thermoset foam.

The present invention relates to solid thermoset foams obtained by chemical reaction and foaming of an expandable composition containing sugars and an acid catalyst.

The manufacture of insulating products based on mineral wool generally comprises a stage of manufacture of glass or rock fibers by a centrifugation process. On their journey between the centrifugation device and the belt for collecting the fibers, an aqueous sizing composition, also known as binder, is sprayed over the fibers, which are still hot, and is subsequently subjected to a thermosetting reaction at temperatures of approximately 200° C.

The phenolic resins used for several decades as binders have been increasingly replaced by products resulting from renewable sources and which emit no or very little formaldehyde, a compound regarded as being potentially harmful to human health.

There are thus known, from the application WO 2007/014236, sizing compositions or binders based on reducing sugars and on amines or on ammonium salts which, inter alia, by a Maillard reaction, cure and bind the glass fibers to which they are applied.

The applications WO 2009/019232 and WO 2009/019235 similarly disclose binders for glass fibers containing at least one reducing sugar and ammonium phosphate, sulfate, nitrate or carbonate, these reactants being capable of reacting by a Maillard reaction after application to the glass fibers directly after formation of the fibers.

The application WO2012/028810 discloses sizing compositions based on nonreducing sugars and on metal salts of inorganic acids capable of curing and binding the glass fibers to which they are applied.

The application WO2012/168621 similarly discloses binders for glass fibers containing at least one nonreducing sugar, at least one catalyst for the dehydration of the nonreducing sugar, at least one amine and at least one activated ethylenic unsaturation, these reactants being capable of reacting after application to the glass fibers directly after formation of the fibers.

Finally, the article entitled “Carbohydrate Dehydration Demonstration” by Dolson et al., published in Journal of Chemical Education, Volume 72, October 1995, describes a test for the detection of carbohydrates by carbonization in the presence of concentrated sulfuric acid. The destruction of the samples by spontaneous reaction with the acid is accompanied by a phenomenon of effervescence (formation of a liquid foam) and by a strong release of heat. The reaction product is a carbonization residue which has no mechanical strength.

The present invention is based on the surprising discovery that certain sizing compositions based on sugars, when they are heated in a fairly concentrated form above a certain temperature (approximately 150° C.), instead of spraying them over hot glass fibers, are strongly foaming. Release of gas takes place at the same time as the curing reaction. The liquid starting composition, introduced into an open container and exposed to a sufficient heat, increases in volume, thickens and finishes by curing, giving rise, after a few minutes, to a rigid dark-colored foam.

The Applicant company has carried out numerous tests in order to determine under what experimental conditions compositions based on reducing or nonreducing sugars form thermoset foams. Without being committed to a specific theory, the applicant company believes that the reaction involved in the curing of the foaming compositions of the present patent application is based on a reaction for dehydration of the sugar, catalyzed by an acid, resulting in the formation of hydroxymethylfurfural (HMF), which is capable of polymerizing.

The subject matter of the present invention is consequently the use of a composition containing:
a sugar, and
an acid catalyst chosen from strong acids, phosphoric acid and acidic inorganic salts, as expandable and thermosetting composition for the manufacture of an insulating product of foam type.

More particularly, the subject matter of the present invention is a process for the manufacture of a solid thermoset foam, which can be used as thermal insulating product, comprising the following successive stages:

(a) making available an expandable and thermosetting composition containing:
a sugar,
an acid catalyst chosen from strong acids, phosphoric acid and acidic inorganic salts,

(b) introducing the expandable and thermosetting composition into a mold or applying the expandable composition to a support as a film with a thickness at least equal to 1 mm,

(c) heating the expandable and thermosetting composition to a temperature at least equal to 140° C., so as to form a block of solid thermoset foam.

The sugar which can be used in the present invention can be a reducing sugar or a nonreducing sugar.

“Reducing sugars” is understood to mean the carbohydrates of formula Cₙ(H₂O)ₚ exhibiting at least one aldehyde or ketone group (reducing group). The reducing sugars which can be used in the present invention encompass monosaccharides and polysaccharides (disaccharides, oligosaccharides and polysaccharides proper).

Use will preferably be made of hexoses, namely sugars comprising six carbon atoms, such as glucose, mannose, galactose and fructose.

The lactose or maltose are examples of disaccharides which can be used as reducing sugars.

Use may also advantageously be made of starch hydrolysates obtained by enzymatic hydrolysis or acid hydrolysis of starch.

The nonreducing sugars preferably used in the present invention are sucrose and trehalose.

Throughout the patent application, the term “sugar”, even used in the singular, always equally encompasses mixtures of reducing and/or nonreducing sugars.

The acid catalyzing the dehydration of the sugar can be a strong acid, that is to say an acid which dissociates completely when it is dissolved in water. The strong acids which can be used encompass hydrohalic acids, namely hydrochloric acid, hydriodic acid and hydrobromic acid, sulfuric acid (H₂SO₄), nitric acid (HNO₃), chloric acid (HClO₃), perchloric acid (HClO₄), manganic acid (H₂MnO₄), permanganic acid (HMnO₄), trifluoroacetic acid and superacids encompassing fluoroantimonic acid (HF.SbF₅), magic acid (HSO₃F.SbF₅), trifluoromethanesulfonic acid (HSO₃CF₃), fluorosulfuric acid (HSO₃F) and disulfuric acid (H₂S₂O₇).

In order to effectively catalyze the foaming and the curing of the expandable compositions, the strong acid has to be used in a concentration at least equal to 0.1 N (pH=1), preferably at least equal to 0.5 N.

Although phosphoric acid is not a strong acid (pKa1 of approximately 2), it can act as acid catalyst for dehydration provided that it is used at a concentration at least equal to 0.1 mol/1, preferably at least equal to 0.2 mol/1.

When the acid catalyst is chosen from strong acids and phosphoric acid, the acid/sugar molar ratio is preferably less than ⅙, preferably between 1/40 and ⅛, in particular between 1/35 and 1/9, ideally between 1/34 and 1/10. When the sugar used contains oligomers or polymers of carbohydrate monomer units (for example starch hydrolysates containing glucose monomer units) the number of mols of sugars is equal to the number of mols of monomer units.

Finally, the acid catalyst can be an acidic inorganic salt. “Acidic inorganic salt” is understood to mean an inorganic salt which, when it is introduced into demineralized water, makes it possible to lower the pH thereof to a value of less than 3.

These acidic inorganic salts do not encompass the inorganic salts of alkali metals and alkaline earth metals but encompass a large number of transition metal salts.

Mention may be made, as examples of acidic inorganic salts, of aluminum, gallium, copper, zinc, silver, nickel, iron and lead sulfates, nitrates, chlorides and bromides.

The applicant company has obtained good results with aluminum sulfate, copper sulfate and copper nitrate, which are particularly preferred.

The acidic inorganic salts will preferably be used in a concentration such that the pH of the composition is less than or equal to 3, preferably less than 2.5 and ideally less than 2.

The expandable and thermosetting compositions used in the present invention for the formation of solid foams generally contain water. This water essentially acts as solvent for the sugar.

Given that the expandable composition used in the process of the present invention does not have to be finely dispersed in air, it is less crucial than in the case of a binder for mineral fibers to take care that its viscosity is sufficiently low. While an aqueous binder for mineral fibers comprises, at the time of the spraying, at least 90%, indeed even 95%, of water, the expandable compositions of the present invention are much more concentrated and viscous.

They advantageously contain at most 60% by weight of water, in particular at most 35% by weight, preferably at most 25% by weight, more preferably at most 15% by weight and ideally at most 5% by weight of water.

The dry matter content of the expandable composition before heating is thus at least equal to 40% by weight, in particular at least equal to 65% by weight, preferably at least equal to 75% by weight, more preferably at least equal to 85% by weight and ideally at least equal to 95% by weight.

The sugar represents, in total, at least 70%, preferably at least 80% and in particular at least 90% of the dry weight of the expandable composition.

Although the sugar and the acid catalyst are the predominant and essential constituents of the expandable composition, the latter can contain a number of other adjuvants and additives intended to improve the properties of the final thermoset foams or to reduce the production costs. The total amount of these adjuvants and additives preferably, however, does not exceed 30% of the dry weight of the expandable composition.

Thus, the expandable composition can contain, for example, one or more surface-active agents intended to reduce the mean dimension and the dispersion in the sizes of the pores of the final foam or to facilitate the incorporation of a filler. The expandable composition advantageously contains from 1 to 15% by weight, preferably from 2 to 10% by weight, with respect to the dry weight of the total expandable composition, of one or more surface-active agents.

The expandable composition used in the present invention can additionally contain up to 20% by weight, preferably up to 10% by weight, with respect to the dry weight of the total expandable composition, of one or more inorganic or organic fillers.

Finally, the expandable composition can contain one or more other additives conventionally used in the industry for the processing and transformation of polymers, such as dyes, pigments, antibacterial or antifungal agents, flame retardants, UV absorbers or hydrophobic agents. These additives represent, in total, preferably at most 10% of the dry weight of the composition.

In the process of the present invention, reactive compositions, known as such in a very dilute form, are thus used in a completely different way from that described in the documents of the state of the art mentioned in the introduction. They are not sprayed in the form of fine droplets over hot mineral fibers for the purpose of the formation of a blanket of fibers adhesively bonded to one another but remain in the compact undispersed form. Their dry matter content is considerably higher than that of the compositions of the state of the art.

When the expandable composition is spread in the form of a continuous film over a support, the thickness of the film before heating, that is to say before expansion and curing, is preferably at least equal to 2 mm, in particular at least equal to 5 mm and more preferably at least equal to 10 mm.

The volume of the block of foam formed can vary between very wide limits. When the expandable composition is used in a continuous process, for example forming strips or profiled elements of insulating materials, it is potentially infinite. When the expandable composition is used to form separate blocks, for example slabs or sheets of foams, its amount is preferably such that the volume of each block of solid thermoset foam is at least equal to 500 cm³, preferably at least equal to 0.001 m³ and in particular at least equal to 0.01 m³.

The block of foam is preferably provided in the form of a slab. In order to react the sugar, it is necessary to heat the expandable composition to a temperature of at least 140° C. The reaction temperature will preferably be between 150° C. and 180° C. This temperature is, of course, that measured at the heart of the reaction mixture.

Use may in principle be made, in order to heat the expandable composition in stage (c), of any standard means known in the field of the processing and transformation of polymers, such as hot air, thermal radiation, microwaves or bringing into contact with a hot support (mold).

Of course, the temperature of the heating means (drying oven, support, mold) can be greater than the abovementioned reaction temperature, for example between 160 and 210° C.

Another subject matter of the present invention is a solid foam capable of being obtained by the process which is a subject matter of the present invention.

The solid foams prepared by the process of the invention are dark brown to black in color. Their density is between 30 and 60 kg/m³.

They exhibit a closed porosity with a mean diameter of the pores, determined by X-ray tomography, of between 100 and 800 nm.

### EXAMPLE 1

Inorganic Salts

Several expandable and thermosetting compositions are prepared by adding an aqueous solution of the acid catalyst (acidic inorganic salt) to a glucose monohydrate powder. The mixture is stirred at ambient temperature in order to disperse the powder.

The respective amounts of sugar and of acidic inorganic salt, expressed as dry matter, the concentration of the acid catalyst in mol/l and also the total solids content of the compositions prepared are shown in table 1a.

Each of the compositions is introduced into a flat-bottomed aluminum dish (diameter of 5 cm) as a film having a thickness of approximately 1 mm. The dishes are introduced into a drying oven heated to 200° C. After 20 minutes, they are removed and allowed to cool at ambient temperature and the thickness of the foam formed is observed:

### Grading Scale:

−: less than 0.5 cm

+: 0.5 to 1 cm

++: 1.1 to 2 cm

+++: 2.1 to 3 cm

++++: 3.1 to 4 cm

+++++: more than 4 cm

TABLE 1a
Acidic inorganic salts

| | Acid | Acid catalyst | Solids | Thickness |
|---|---|---|---|---|
| Sugar | catalyst | concentration | content | of the foam |
| 85 parts of | 15 parts | 0.6 mol/l | 60% | +++++ |
| D-glucose | Al₂(SO₄)₃ | | | |
| monohydrate | | | | |
| 92.5 parts of | 7.5 parts | 0.3 mol/l | 60% | +++++ |
| D-glucose | Al₂(SO₄)₃ | | | |
| monohydrate | | | | |
| 98.5 parts of | 1.5 parts | 0.06 mol/l | 60% | +++++ |
| D-glucose | Al₂(SO₄)₃ | | | |
| monohydrate | | | | |
| 99.85 parts of | 0.15 parts | 0.006 mol/l | 60% | +++++ |
| D-glucose | Al₂(SO₄)₃ | | | |
| monohydrate | | | | |
| 85 parts of | 15 parts of | 1.4 mol/l | 60% | +++++ |
| D-glucose | CuSO₄ | | | |
| monohydrate | | | | |
| 85 parts of | 15 parts of | 1.2 mol/l | 60% | +++++ |
| D-glucose | Cu(NO₃)₂ | | | |
| monohydrate | | | | |

The foams formed are all brown to black in color.

By way of comparison, similar compositions are prepared, either by omitting the acid catalyst or by replacing the acidic inorganic salts (Al₂(SO₄)₃, CuSO₄ and Cu(NO₃)₂) with inorganic salts which do not make it possible to acidify the composition down to a pH of less than 3.

The results are presented in table 1b below.

TABLE 1b
Comparative inorganic salts

| | Acid | Acid catalyst | Solids | Thickness |
|---|---|---|---|---|
| Sugar | catalyst | concentration | content | of the foam |
| 100 parts of | — | — | 60% | − |
| D-glucose | | | | |
| monohydrate | | | | |
| 85 parts of | 15 parts of | 1.9 mol/l | 60% | − |
| D-glucose | MgSO₄ | | | |
| monohydrate | | | | |
| 85 parts of | 15 parts of | 1.3 mol/l | 60% | − |
| D-glucose | CaSO₄ | | | |
| monohydrate | | | | |
| 85 parts of | 15 parts of | 1.8 mol/l | 60% | − |
| D-glucose | AlPO₄ | | | |
| monohydrate | | | | |
| 85 parts of | 15 parts of | 3.9 mol/l | 60% | − |
| D-glucose | NaCl | | | |
| monohydrate | | | | |

These samples are from yellow to caramel in color after curing for 20 minutes. No formation of foam is observed.

### EXAMPLE 2

Strong Acids and Phosphoric Acid

Several expandable and thermosetting compositions are prepared by adding, to 9 g of a glucose monohydrate powder, 6 ml of an aqueous solution of the acid catalyst (strong acid or phosphoric acid) having the concentration shown in tables 2a and 2b. The mixture is stirred at ambient temperature in order to disperse the powder therein.

The concentration of mol/l of the acid catalyst used and also the total solids content of the compositions prepared are shown in table 2a.

Each of the compositions is introduced into a flat-bottomed aluminum dish (diameter of 5 cm) as a film having a thickness of approximately 1 mm. The dishes are introduced into a drying oven heated to 200° C. After 20 minutes, they are removed and allowed to cool at ambient temperature and the thickness of the foam formed is observed. The grading scale is identical to that of example 1.

TABLE 2a
Strong acids and phosphoric acid

| | | | Acid | | Thick- |
|---|---|---|---|---|---|
| | | Acid | catalyst | | ness |
| | Acid | catalyst | concen- | Solids | of the |
| Sugar | catalyst | weight | tration | content | foam |
| 100 parts of | HCl | 219 mg | 1 mol/l | 60% | +++++ |
| D-glucose | | | | | |
| monohydrate | | | | | |
| 100 parts of | H₂SO₄ | 164 mg | 0.28 mol/l | 60% | +++++ |
| D-glucose | | | | | |
| monohydrate | | | | | |
| 100 parts of | H₂SO₄ | 59 mg | 0.1 mol/l | 60% | +++++ |
| D-glucose | | | | | |
| monohydrate | | | | | |
| 100 parts of | HNO₃ | 453 mg | 1.2 mol/l | 60% | ++ |
| D-glucose | | | | | |
| monohydrate | | | | | |
| 100 parts of | H₃PO₄ | 118 mg | 0.20 mol/l | 60% | ++++ |
| D-glucose | | | | | |
| monohydrate | | | | | |

Hydrochloric acid, sulfuric acid and phosphoric acid used at a concentration greater than or equal to 0.1 mol/l give voluminous foams from brown to black in color. Inexplicably, nitric acid, even at a high concentration, foams to a relatively lesser extent than the other acids.

By way of comparison, the same acids are used in a concentration of 0.01 mol/l. The results are presented in table 2b below.

TABLE 2b
Strong acids and phosphoric acid (comparative)

| | | | Acid | | Thick- |
|---|---|---|---|---|---|
| | | Acid | catalyst | | ness |
| | Acid | catalyst | concen- | Solids | of the |
| Sugar | catalyst | weight | tration | content | foam |
| 100 parts of | HCl | 2 mg | 0.01 mol/l | 60% | − |
| D-glucose | | | | | |
| monohydrate | | | | | |
| 100 parts of | H₂SO₄ | 6 mg | 0.01 mol/l | 60% | − |
| D-glucose | | | | | |
| monohydrate | | | | | |
| 100 parts of | HNO₃ | 4 mg | 0.01 mol/l | 60% | − |
| D-glucose | | | | | |
| monohydrate | | | | | |
| 100 parts of | H₃PO₄ | 6 mg | 0.01 mol/l | 60% | − |
| D-glucose | | | | | |
| monohydrate | | | | | |

No foam is formed.

The applicant company has also carried out a series of tests by bringing D-glucose into contact with increasing amounts of acetic acid (weak acid) and by heating the mixture under the same conditions. Even in a concentration of acetic acid of greater than 15 mol/l, no formation of foam is observed.

1. A process for manufacturing a solid thermoset foam comprising the following successive stages:
(a) making available an expandable and thermosetting composition containing:
a sugar, and
an acid catalyst chosen from strong acids, phosphoric acid and acidic inorganic salts, a concentration of strong acids being at least equal to 0.1 N, a concentration of phosphoric acid being at least equal to 0.1 mol/l and a concentration of acidic inorganic salts being such that the pH of the composition is less than or equal to 3, the acidic inorganic salts being chosen from aluminum, gallium, copper, zinc, silver, nickel, iron and lead sulfates, nitrates, chlorides and bromides,
(b) introducing the expandable and thermosetting composition into a mold or applying the expandable composition to a support as a film with a thickness at least equal to 1 mm, and
(c) heating the expandable and thermosetting composition to a temperature at least equal to 140° C., so as to form a block of solid thermoset foam.

2. The process as claimed in claim 1, wherein, when the acid catalyst is chosen from a group formed by strong acids and phosphoric acid, the acid/sugar molar ratio is less than ⅙.

3. The process as claimed in claim 1, wherein the thickness of the film is at least equal to 2 mm.

4. The process as claimed in claim 1, wherein the block of solid thermoset foam is a slab.

5. The process as claimed in claim 1, wherein the expandable composition contains at most 60% by weight of water.

6. The process as claimed in claim 1, wherein the sugar represents at least 70% of the dry weight of the expandable composition.

7. The process as claimed in claim 1, wherein the sugar is chosen from reducing sugars and nonreducing sugars.

8. The process as claimed in claim 7, wherein the sugar is a reducing sugar chosen from glucose and starch hydrolysates.

9. The process as claimed in claim 1, wherein the concentration of strong acid is between 0.1 and 1.5 N.

10. The process as claimed in claim 1, wherein the expandable composition additionally contains up to 20% by weight, with respect to the dry weight of the total expandable composition, of one or more inorganic or organic fillers.

11. A solid foam produced by the process as claimed in claim 1.

12. The solid foam as claimed in claim 11, wherein the solid foam exhibits a density of between 30 and 60 kg/m³.

13. The solid foam as claimed in claim 11, wherein the solid foam exhibits a closed porosity.

14. The solid foam as claimed in claim 11, wherein a mean diameter of pores of the solid foam, determined by X-ray tomography, is between 100 and 800 nm.

15. A composition containing:
a sugar, and
an acid catalyst chosen from strong acids, phosphoric acid and acidic inorganic salts,
wherein the composition is an expandable and thermosetting composition for manufacturing an insulating product of foam type.

16. The process as claimed in claim 1, wherein, when the acid catalyst is chosen from a group formed by strong acids and phosphoric acid, the acid/sugar molar ratio is between 1/34 and 1/10.

17. The process as claimed in claim 1, wherein the thickness of the film is at least equal to 10 mm.

18. The process as claimed in claim 1, wherein the expandable composition contains at most 5% by weight of water.

19. The process as claimed in claim 1, wherein the sugar represents at least 90% of the dry weight of the expandable composition.

20. The process as claimed in claim 1, wherein the sugar is chosen from reducing sugars.
